(19) United States
(12) Patent Application Publication
(10) Pub. No.: US 2026/0310187 A1
(43) Pub. Date: Oct. 8, 2026

(54) CONSTRUCTION ASSET MONITORING SYSTEMS AND METHODS

(71) Applicant: DORNAN ENGINEERING SERVICES LIMITED, LONDON (GB)

(72) Inventor: BRYAN WHITE, GREATER LONDON (GB)

(73) Assignee: DORNAN ENGINEERING SERVICES LIMITED, LONDON, GB (GB)

(21) Appl. No.: 19/479,061

(22) PCT Filed: Apr. 26, 2024
(86) PCT No.: PCT/GB2024/051102

§ 371 Date: Oct. 27, 2025

(30) Foreign Application Priority Data
Apr. 28, 2023 (GB) 2306357.1

(51) Int. Cl. G05B 19/418; G06K 7/14

(52) U.S. Cl. CPC G05B 19/41875; G06K 7/1417

(57) ABSTRACT

Disclosed is a quality control method for a construction asset, comprising: assembling a construction asset having a design weight; weighing the asset before deployment to determine its actual weight; and notifying a user if the actual weight falls outside a safety tolerance with respect to the design weight. Also disclosed is a method for monitoring a construction asset, comprising: storing asset characteristics associated with the construction asset in an asset monitoring application; linking a unique scannable tag to the asset characteristics; tagging the construction asset with the unique scannable tag; and scanning the tag to access the asset characteristics. Associated systems are also disclosed.

### FIELD

The invention relates to monitoring construction assets and to construction asset quality control.

### BACKGROUND

Construction assets are used in the construction industry to deliver projects according to design plans. Typically, the requirements for each construction asset are laid out in a design phase, and the construction assets are then assembled according to the design criteria specified in design plans.

Construction assets must comply with their design criteria to ensure the safety of the construction. However, assembled construction assets can differ from the intended design, thereby causing safety risks. Verifying the safety of an assembled construction asset can require comparison of the assembled asset to the design criteria to identify any defects.

Construction asset monitoring systems and methods are therefore required to ensure that construction assets comply with their design criteria.

### BRIEF DESCRIPTION OF THE INVENTION

Disclosed is a quality control method for a construction asset, comprising: assembling a construction asset having a design weight; weighing the asset before deployment to determine its actual weight; and notifying a user if the actual weight falls outside a safety tolerance with respect to the design weight.

The construction asset may be a complex construction asset comprising a plurality of component parts permitting disassembly and reassembly of the complex construction asset.

The method may further include deploying the asset if the actual weight falls within the safety tolerance with respect to the design weight.

The method may further include inputting the actual weight to an asset monitoring application and verifying if the actual weight passes one or more asset weight checks held in the asset monitoring application, wherein the asset design weight is held in the asset monitoring application.

The method may further include preventing the deployment of the asset if the asset does not pass one or all of the asset weight checks.

When the asset does not pass one or all of the asset weight checks, the method may include modifying an asset deployment plan based on the actual weight to generate a modified asset deployment plan that is compatible with the actual weight, and optionally deploying the asset according to the modified asset deployment plan.

The method may further include: scanning a unique tag associated with the asset to access asset characteristics held in the asset monitoring application including the asset design weight; and updating the asset characteristics with the actual weight.

The asset characteristics may be automatically updated with the actual weight.

The notification that the actual weight falls outside a safety tolerance with respect to the design weight may be issued automatically by the asset monitoring application.

Also disclosed is a quality control system for a construction asset, comprising: a processing device configured to run an asset monitoring application and operable to communicate with a storage device holding asset characteristics including an asset design weight for the construction asset, wherein the asset monitoring application is configured to receive an actual asset weight for the construction asset and to compare the actual asset weight to the asset design weight, wherein the asset monitoring application is configured to notify a user if the actual asset weight falls outside a safety tolerance with respect to the asset design weight.

The system may further include a scannable tag for association with the construction asset, and the scannable tag may be linked to the asset characteristics.

The scannable tag may be a QR code.

The system may further include a user device configured to scan the scannable tag.

Also disclosed is a method for monitoring a construction asset, comprising: storing asset characteristics associated with the construction asset in an asset monitoring application; linking a unique scannable tag to the asset characteristics; tagging the construction asset with the unique scannable tag; and scanning the tag to access the asset characteristics.

The method may further include displaying the asset characteristics to a user.

The construction asset may be a complex construction asset comprising a plurality of component parts permitting disassembly and reassembly of the complex construction asset.

The asset characteristics may include safety criteria associated with the asset.

The method may further include verifying that the asset complies with the safety criteria.

The method may further include notifying a user if the asset does not comply with the safety criteria.

The method may further include deploying the asset if the asset complies with the safety criteria, and preventing the deployment of the asset if the asset does not comply with the safety criteria.

The method may further include designing the asset and generating the safety criteria.

The method may further include assembling the asset.

The step of scanning the tag may be performed by a first entity, and the method may further include transferring the asset from the first entity to a second entity, and the second entity scanning the tag to access the asset characteristics.

Also disclosed is a construction asset monitoring system, comprising: a processing device configured to run an asset monitoring application and operable to communicate with a storage device holding asset characteristics associated with a construction asset, wherein the asset monitoring application is operable to associate a unique scannable tag with the asset characteristics, wherein the tag is scannable to access the asset characteristics.

The system may further include a user device configured to scan the scannable tag and/or a user device configured to display the asset characteristics.

### BRIEF DESCRIPTION OF THE FIGURES

In order that the present disclosure may be more readily understood, preferable embodiments thereof will now be described, by way of example only, with reference to the accompanying drawings, in which:

FIG. 1 is a schematic illustration of a system according to the present disclosure;

FIG. 2 is a schematic illustration of assets according to the present disclosure;

FIGS. 3 and 4 show parts of an asset monitoring application according to the present disclosure;

FIG. 5 shows an example of an asset drawing according to the present disclosure;

FIGS. 6-10 show parts of an asset monitoring application according to the present disclosure;

FIG. 11 illustrates a method according to the present disclosure;

FIGS. 12-13 illustrate a method according to the present disclosure;

FIGS. 14-16 show examples of complex assets according to the present disclosure; and

FIG. 17 is a schematic representation of a processing device and storage device according to the present disclosure.

### DETAILED DESCRIPTION OF THE DISCLOSURE

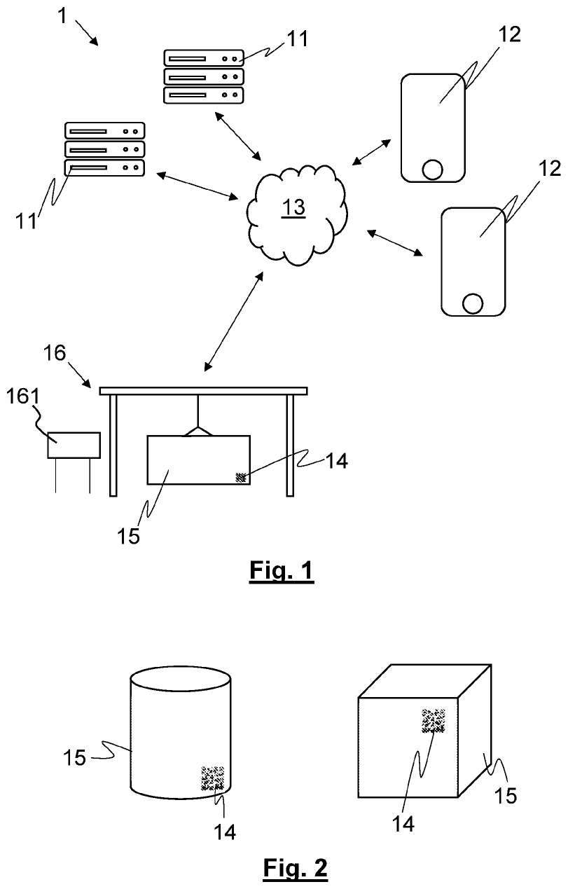

The disclosed technology includes an asset monitoring system 1 and associated methods (see e.g. FIGS. 1 and 10-12). The asset monitoring system 1 may be configured for monitoring construction assets and may, therefore, be referred to as a construction asset monitoring system 1. In other implementations, the monitoring system 1 may be used to monitor assets other than construction assets.

The asset monitoring system 1 may include a server 11, a user device 12, and/or a network 13. The asset monitoring system 1 may include a plurality of servers 11, user devices 12, and/or networks 13. In some cases a server 11 may function as a user device 12 and/or a user device 12 may function as a server 11. The or each server 11 and the or each user device 12 may be communicatively coupled, for example via the network 13. The user device 12 may be a smartphone, tablet, or similar computing device.

The asset monitoring system 1 may include a tag 14 or a plurality of tags 14. Each tag 14 may be unique, and may therefore be referred to as a unique tag 14. The tag 14 may be a scannable tag 14. The tag 14 may be a machine-readable tag 14. The tag 14 may include an RFID tag, an NFC tag, and/or a machine-readable code such as a barcode or QR code. The tag 14 may, in particular, include a QR code, which may provide a simple, cheap, easy-to-produce tag 14. The tag 14 may be configured for attachment to an asset 15. For example, the tag 14 may include an adhesive portion.

The user device 12 may be configured to scan the tag 14. In some implementations, a separate tag scanning device may be provided for scanning the tag 14. The tag scanning device may be communicatively coupled to the user device 12, server 11, and/or network 13.

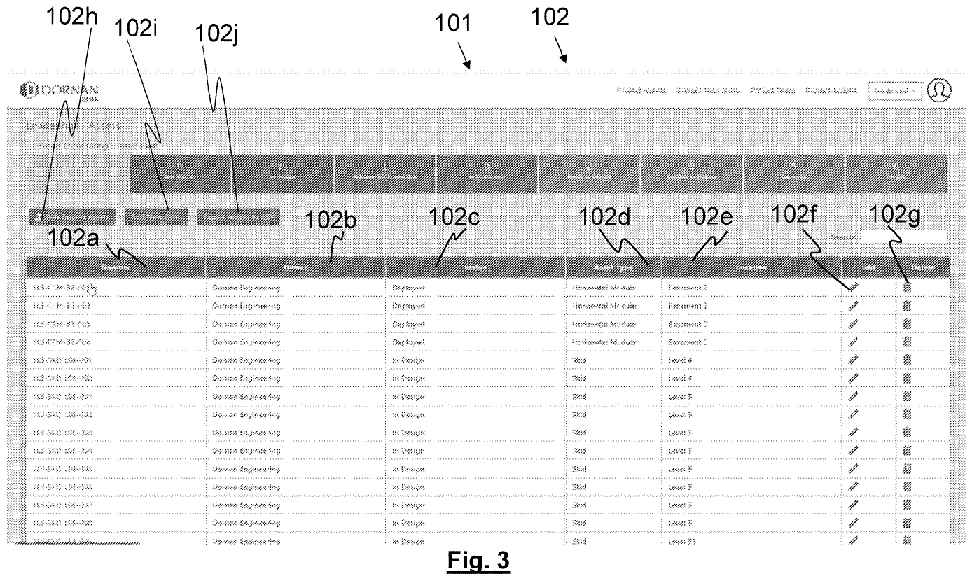

The asset monitoring system 1 may include an asset 15 or plurality of assets 15, which may be one or more construction assets 15 (see e.g. FIG. 2). A construction asset 15 could be any asset 15 used to construct a construction. The asset 15 may, therefore, form part of the finished construction. Examples of constructions include buildings, bridges, tunnels, roads, sewers, and so on. Examples of buildings include public, commercial, and residential buildings, such as hospitals, factories, and houses. It will be appreciated that the particular nature of the construction is not limiting.

The asset 15 may have a design weight. The design weight may be a predicted weight based on the design of the asset 15. The design weight may be generated during the design of the asset 15 and/or before the asset 15 is assembled. The design weight may, therefore, be an expected weight of the asset 15. The asset 15 may have an actual weight. The actual weight may be the weight of the assembled asset 15, which may be determined using a weighing device 16. The actual weight may, therefore, differ from the design weight, which may pose a safety risk. The asset design and actual weights are examples of asset characteristics. The asset design weight is also an example of a safety criterion, as deviation of the asset actual weight from the design weight may pose a safety risk.

The asset 15 may be a complex asset 15. A complex asset 15 may include a plurality of component parts permitting disassembly and reassembly of the complex asset 15. A complex asset 15 could, therefore, include a prefabricated construction module (see e.g. FIG. 14). Examples of prefabricated construction modules include prefabricated laboratories, plant rooms, bathrooms, kitchens, and/or elevator systems. A prefabricated construction module may provide a service for an end user.

One or more of the component parts of the complex asset 15, optionally each component part of the complex asset 15, may be associated with corresponding component safety criteria.

The complex asset 15 may include one or more conduits, which may be configured to receive fluids and/or electrical wiring.

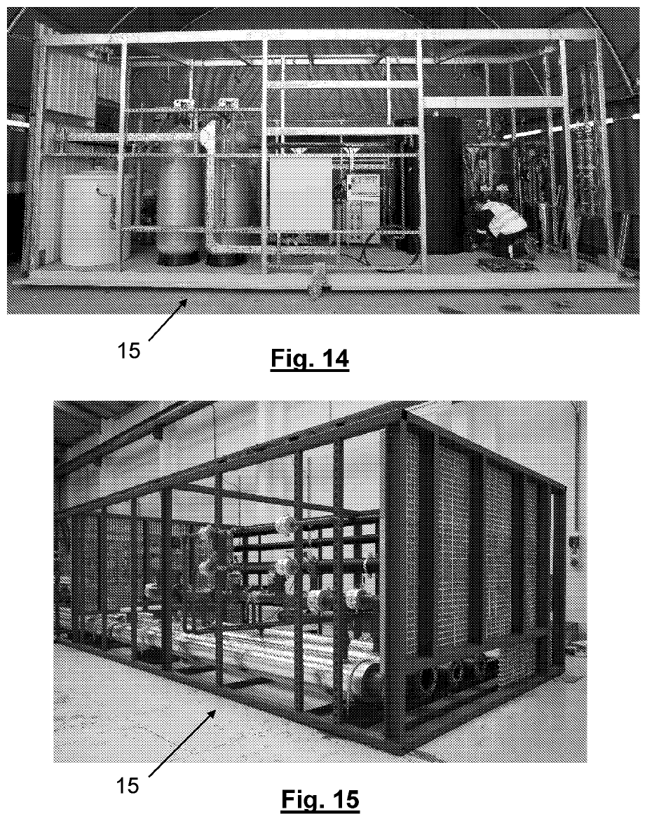

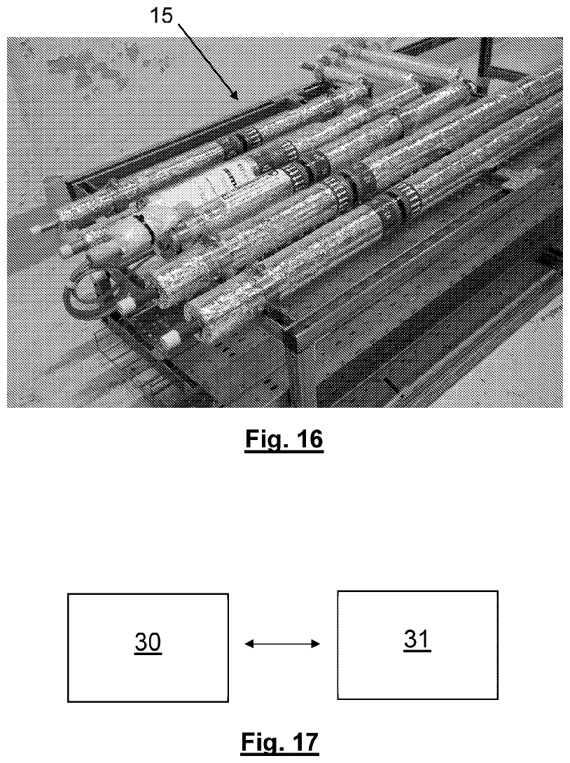

Examples of assets 15 include skids, modules, valve sets, fan coil units, packaged plant rooms, and prefabricated construction modules. An example of a plant room asset 15 is shown in FIG. 14; FIG. 15 shows an example of a riser module asset 15; and FIG. 16 shows an example of a distribution module asset 15.

In some implementations the asset or assets 15 may not be considered part of the asset monitoring system 1. The asset monitoring system 1 may, therefore, be configured to monitor one or more assets 15, which may not themselves be a part of the asset monitoring system 1.

The tag 14 may be associated with the asset 15 (or each tag 14 may be associated with an individual asset 15 in implementations having a plurality of assets 15 and tags 14). The asset 15 may be tagged with the tag 14. The tag 14 may, therefore, identify the asset 15. The tag 14 may link to asset characteristics associated with the asset 15, as described below. The tag 14 may, therefore, enable a user to access information about the asset 15 (i.e. asset characteristics), which may in turn be used to ensure the safety of the asset 15.

The asset monitoring system 1 may include a weighing device 16 (see e.g. FIG. 1). The weighing device 16 may be configured to weigh the or each asset 15. The weighing device 16 may be communicatively coupled to the network 13. The weighing device 16 may be communicatively coupled to the user device 12. The weighing device 16 may be communicatively coupled to the server 11. The weighing device 16 may include a display 161 configured to display the asset weight. The weighing device 16 may include a hook, strap, or other engaging member to engage the asset 15 to lift the asset 15 for weighing. The asset 15 may, therefore, be suspended from a part of the weighing device 16 for weighing. The weighing device 16 may include a plate or other surface configured to receive the asset 15, onto which the asset 15 can be placed for weighing.

The asset monitoring system 1 may include an asset monitoring application 10. The asset monitoring application 10 may be a web application. The asset monitoring application 10 may be a cloud-based application. The asset monitoring application 10 may be accessible via the user device 12. One or more parts of the asset monitoring application 10 may be stored on the server 11. The asset monitoring application 10 may be accessible via the network 13. The asset monitoring application 10 may be a distributed application; in other words, one or more parts of the application 10 may be stored in a first location (e.g. a first server 11) and one or more parts of the application may be stored in a second location (e.g. a second server 11).

The asset monitoring application 10 may run on a processing device 30. The processing device 30 may, therefore, be configured to execute or run the asset monitoring application 10. The processing device 30 may be operable to communicate with a storage device 31, which may be a part of the server 11 and/or user device 12, for example. The storage device 31 may store data for the asset monitoring application 10, including for example asset characteristics. The storage device 31 may include a non-transitory computer-readable medium.

The asset monitoring application 10 may include a user interface 101 (see e.g. FIGS. 1-2, 4-7). A user may, therefore, interact with the asset monitoring application 10, for example to access, create, and/or update asset characteristics.

The asset monitoring application 10 may require a user to have a user profile to access one or more parts of the asset monitoring application 10. The asset monitoring application 10 may require user authentication to access one or more parts of the asset monitoring application 10. The user authentication may include a username and password, for example.

A user profile may include an associated permissions level. One or more parts of the asset monitoring application 10 may have an associated permissions level. A user may only be able to access parts of the asset monitoring application 10 at or below their permissions level. In some versions, a user may be able to view parts of the asset monitoring application 10 having a permissions level above the user's permissions level, but may only be able to edit parts of the asset monitoring application 10 at or below their permissions level.

The asset monitoring application 10 may include a project interface 102 (see e.g. FIG. 3). The project interface 102 may be configured to enable a user to set up a new project (e.g. construction project) on the asset monitoring application 10. The project interface 102 may include an overview of the assets 15 associated with a project. The project interface 102 may list all assets 15 associated with a project, or a subset of the assets 15 associated with the project. The project interface 102 may provide an overview of the number of assets on a project that are assigned to a contractor, not yet started, in design, released for production, in production, ready to deploy, confirmed to deploy, deployed, and/or on site.

The project interface 102 may display asset characteristics including asset label 102a (e.g. name or number), asset owner 102b, asset status 102c, asset type 102d, and/or asset location 102e. The asset status may include not yet started, in design, released for production, in production, ready to deploy, confirmed to deploy, deployed, and/or on site. The asset characteristics may be editable in the project interface 102. The asset characteristics may be removable from the project interface 102. In other words, the project interface 102 may include an asset removal interactive component 102f for removing an asset from a project. The project interface 102 may include an asset editing interactive component 102g for editing one or more asset characteristics.

The project interface 102 may include one or more asset import interactive components 102h,i for adding assets 15 to the project. The one or more asset import interactive components 102h,i may include a bulk asset import interactive component 102h and/or a single asset import interactive component 102i. The bulk asset import interactive component 102h may enable bulk addition of assets 15 to the project (i.e. addition of multiple assets 15 to the project in one transaction). The single asset import interactive component 102i may enable addition of a single asset 15 to the project.

The project interface 102 may include an asset export interactive component 102j, which may be configured to export one or more assets 15 associated with the project. The asset export interactive component 102j may, therefore, be configured to export asset characteristics in a machine-readable format, such as a csv file.

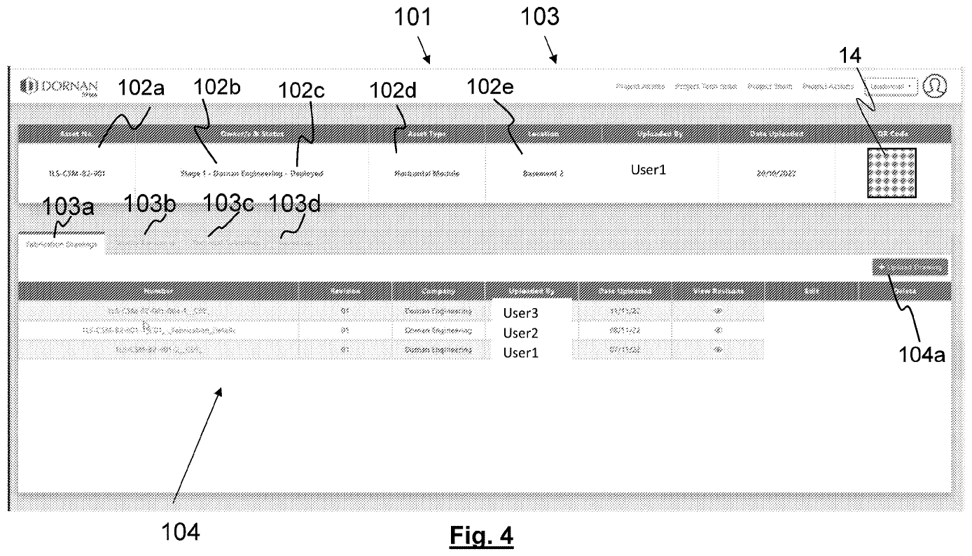

The asset monitoring application 10 may include an asset interface 103 (see e.g. FIG. 4). The asset interface 103 may display characteristics associated with a particular asset 15 (i.e. a single asset 15). Each asset 15 may, therefore, have a corresponding asset interface 103, which may be a dedicated asset interface 103 for that asset 15. The project interface 102 may include a link to the asset interface 103 (and may include a link to each asset interface 103 when there are a plurality of asset interfaces 103, e.g. when there are a plurality of assets 15 associated with a project). For example, the asset label 102a displayed on the project interface 102 may link to the asset interface 103 for that asset 15. The asset interface 103 may display asset characteristics such as fabrication drawings, quality assurance criteria, technical submittals, and/or an issues log for the asset 15. The asset interface 103 may include a representation of the tag 14 associated with the asset 15. For example, the tag 14 may include a QR code and the QR code may be displayed on the asset interface 103.

The asset interface 103 may display asset characteristics including asset label 102a (e.g. name or number), asset owner 102b, asset status 102c, asset type 102d, and/or asset location 102e.

The tag 14 associated with the asset 15 may link to the asset interface 103 for that asset 15. As described, the tag 14 may be a unique scannable tag 14. Each tag 14 may, therefore, link to a unique asset interface 103 (i.e. the asset interface 103 for a particular asset 15). For example, the tag 14 may include a QR code, which may link to the asset interface 103 when scanned by a user device 12. The tag 14 may, therefore, link to asset characteristics for the asset 15. The tag 14 may enable a user to access asset characteristics associated with the asset 15.

The asset interface 103 may include an asset drawings interface 104. The asset interface 103 may include a link to the asset drawings interface 104. For example, the asset interface 103 may include an asset drawings interactive component 103a that links to the asset drawings interface 104. The asset drawings interface 104 may be displayed within the asset interface 103.

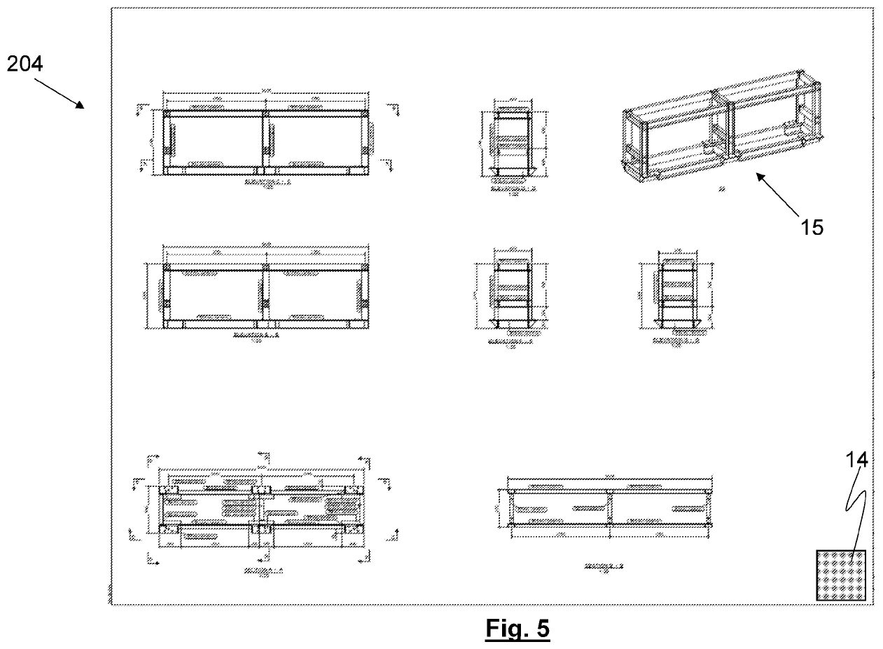

The asset drawings interface 104 may display asset drawings 204 (see e.g. FIG. 5) associated with the asset 15. The asset drawings interface 104 may display a list of asset drawings 204 associated with the asset 15. The asset drawings interface 104 may include one or more links to asset drawings 204 associated with the asset 15. For example, the asset drawings interface 104 may include a list of asset drawings 204 associated with the asset 15, and the entries in the list may link to a corresponding asset drawing 204. A user may, therefore, view asset drawings 204 for the asset 15. The asset drawings 204 are an example of an asset characteristic. Accordingly, the tag 14 may link to, or enable a user to access, the asset drawings 204 for the asset 15. The user may then use the asset drawings 204 to verify that the asset 15 complies with safety criteria.

The asset drawings interface 104 may include a drawing addition interactive component 104a for adding asset drawings 204 to the asset characteristics. The drawing addition interactive component 104a may enable bulk addition of asset drawings 204 and/or single addition of an asset drawing 204. The asset drawings 204 may, therefore, be uploaded to the asset monitoring application 10, and may be stored on the server 11, for example.

The asset drawings 204 may include further asset characteristics, such as dimensions, weights, materials, configurations, and so on. The asset drawings 204 may, therefore, include one or more safety criteria with which the asset 15 must comply. For example, the asset dimensions, weight, material etc. may be safety critical for asset deployment and/or installation. The asset drawings 204 can, therefore, be used by a user to verify that the asset 15 complies with the safety criteria. The asset drawings 204 can, therefore, be considered an example of a safety criterion with which the asset 15 must comply (i.e. the asset 15 must correspond to the asset drawings to ensure asset safety, and any discrepancy between the asset drawings and asset 15 may cause a safety risk).

The asset drawings 204 may include a representation of the tag 14 associated with the asset 15. For example, the asset drawings 204 may include a QR code associated with the asset 15. The tag 14 may, therefore, provide a link between the asset 15 and the asset drawings 204. The tag 14 may, therefore, be used to verify that the asset drawings 204 correspond to the asset 15. For example, a discrepancy between the tag 14 attached to the asset 15 and the tag 14 represented on the asset drawings 204 may indicate an error (e.g. that the asset drawings 204 do not correspond to that asset 15).

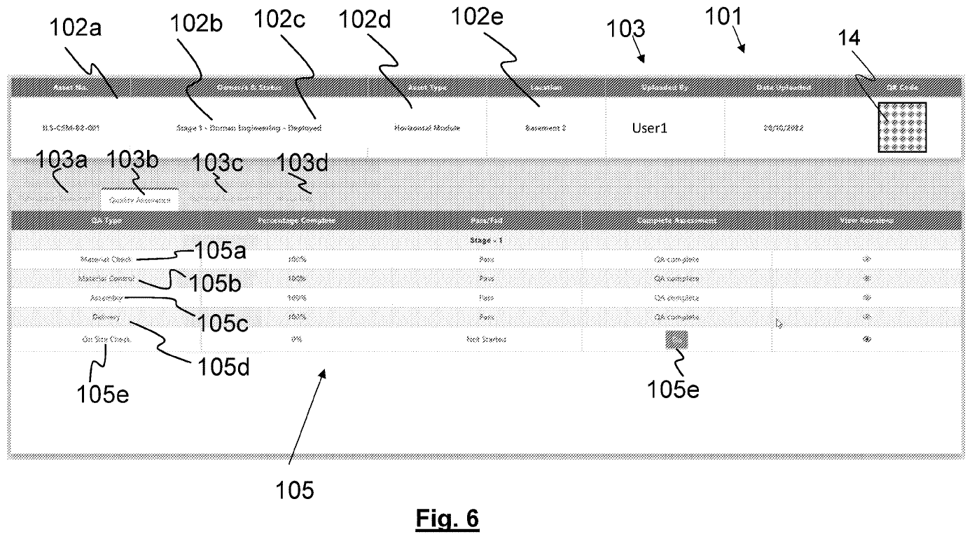

The asset interface 103 may include an asset quality assurance interface 105 (see e.g. FIG. 6). The asset interface 103 may include a link to the asset quality assurance interface 105. For example, the asset interface 103 may include an asset quality assurance interactive component 103b that links to the asset quality assurance interface 105. The asset quality assurance interface 105 may be displayed within the asset interface 103. The asset quality assurance interface 105 may include quality assurance criteria for the asset 15, which may be criteria with which the asset 15 must comply in order to be approved for deployment.

The asset quality assurance interface 105 may include a material check interface (not shown). The asset interface 103, and optionally the asset quality assurance interface 105, may include a link to the material check interface. For example, the asset quality assurance interface 105 may include a material check interactive component 105a that links to the material check interface 105. The material check interface may be displayed within the asset quality assurance interface 105. The material check interface may be displayed in a pop-up window. The material check interface may include asset material checks, such as quality assurance and/or quality control checks regarding the asset material. The material check interface may include editable statuses for the asset material checks (e.g. acceptable, unacceptable, not applicable (n/a)).

The material check interface may include a master status that determines if the asset 15 passes the asset material checks. The master status may be set to acceptable or unacceptable (or pass/fail or other equivalent). If the master status is set to acceptable, the asset 15 may pass the asset material check, and may proceed to the next stage of quality assurance. The master status may be set to acceptable automatically if the asset 15 passes each asset material check. The master status may be set to acceptable manually. In some implementations the master status may be set to acceptable manually even if the asset fails one or more asset material checks. The master status may determine whether or not the asset passes this stage of quality assurance. For example, if the master status is set to acceptable, the asset 15 may pass this stage of quality assurance, even if the asset failed one or more of the asset material checks.

The asset quality assurance interface 105 may include a material control interface (not shown). The asset interface 103, and optionally the asset quality assurance interface 105, may include a link to the material control interface. For example, the asset quality assurance interface 105 may include a material control interactive component 105b that links to the material control interface. The material control interface may be displayed within the asset quality assurance interface 105. The material control interface may be displayed in a pop-up window. The material control interface may include asset material control checks, such as quality assurance and/or quality control checks regarding the asset material control. The material control interface may include editable statuses for the asset material control checks (e.g. acceptable, unacceptable, not applicable (n/a)).

The material control interface may include a master status that determines if the asset 15 passes the asset material control checks. The master status may be set to acceptable or unacceptable (or pass/fail or other equivalent). If the master status is set to acceptable, the asset 15 may pass the asset material control check, and may proceed to the next stage of quality assurance. The master status may be set to acceptable automatically if the asset 15 passes each asset material control check. The master status may be set to acceptable manually. In some implementations the master status may be set to acceptable manually even if the asset fails one or more asset material control checks. The master status may determine whether or not the asset passes this stage of quality assurance. For example, if the master status is set to acceptable, the asset 15 may pass this stage of quality assurance, even if the asset failed one or more of the asset material control checks.

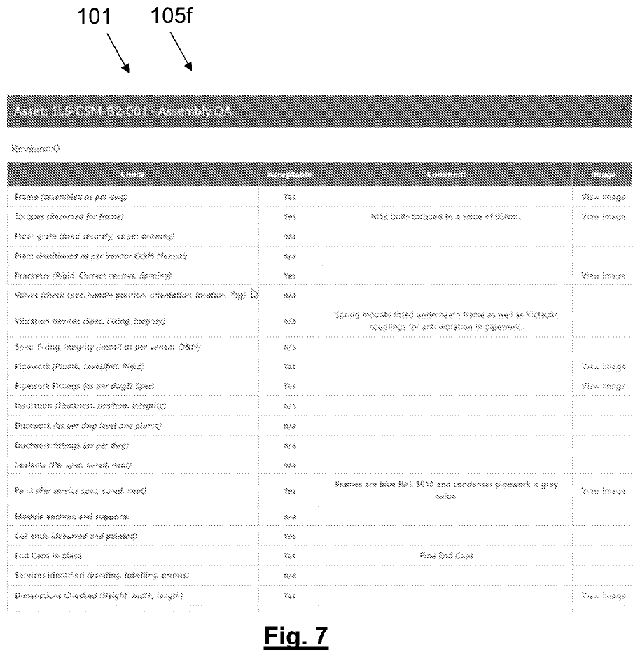

The asset quality assurance interface 105 may include an assembly interface 105f (see e.g. FIG. 7). The asset interface 103, and optionally the asset quality assurance interface 105, may include a link to the assembly interface 105f. For example, the asset quality assurance interface 105 may include an assembly interactive component 105c that links to the assembly interface 105f. The assembly interface 105f may be displayed within the asset quality assurance interface 105. The assembly interface 105f may be displayed in a pop-up window. The assembly interface 105f may include asset assembly checks, such as quality assurance and/or quality control checks regarding the assembly of the asset 15. The assembly interface 105f may include editable statuses for the asset assembly checks (e.g. acceptable, unacceptable, not applicable (n/a)).

The assembly interface 105f may include a master status that determines if the asset 15 passes the asset assembly checks. The master status may be set to acceptable or unacceptable (or pass/fail or other equivalent). If the master status is set to acceptable, the asset 15 may pass the asset assembly check, and may proceed to the next stage of quality assurance. The master status may be set to acceptable automatically if the asset 15 passes each asset assembly check. The master status may be set to acceptable manually. In some implementations the master status may be set to acceptable manually even if the asset fails one or more asset assembly checks. The master status may determine whether or not the asset passes this stage of quality assurance. For example, if the master status is set to acceptable, the asset 15 may pass this stage of quality assurance, even if the asset failed one or more of the asset assembly checks.

For example, asset assembly checks may include checking an asset frame is assembled as per the corresponding asset drawing 204; checking component torques; checking a floor grate is fixed securely, as per the corresponding asset drawing 204; checking plant is positioned as per an operation and maintenance requirement; checking bracketry is rigid with correct centres and spacing; checking valves specification, handle position, orientation, location and tag; checking vibration devices specification, fixing and integrity; checking pipework is plumb, rigid, and with the correct level/fall; checking pipework fittings are as per the asset drawings 204 and specification; checking insulation thickness, position, and integrity; checking ductwork is as per the asset drawings 204, and is level and plumb; checking ductwork fittings are as per the asset drawings 204; checking sealants are as per specification, cured, and neat; checking module anchors and supports; checking cut ends are deburred and painted; checking end caps are in place; checking services are identified with banding, labelling, and/or arrows; and/or checking asset dimensions including height, width and length.

The user may edit the status of each asset assembly check in the assembly interface 105f. The asset assembly interface 105f may include a comment section for each asset assembly check. The comment section may enable a user to leave a comment on the or each asset assembly check. The comment may, therefore, be displayed in the assembly interface 105f, if present. The asset assembly interface 105f may include an image section for each asset assembly check. The image section may enable the user to add an image associated with the or each asset assembly check. The image may be displayed directly in the assembly interface 105f or the image section may include a link to the or each image, which may be displayed in a pop up window, for example. The user may, therefore, upload one or more images to the asset monitoring application 10 to support the asset assembly checks.

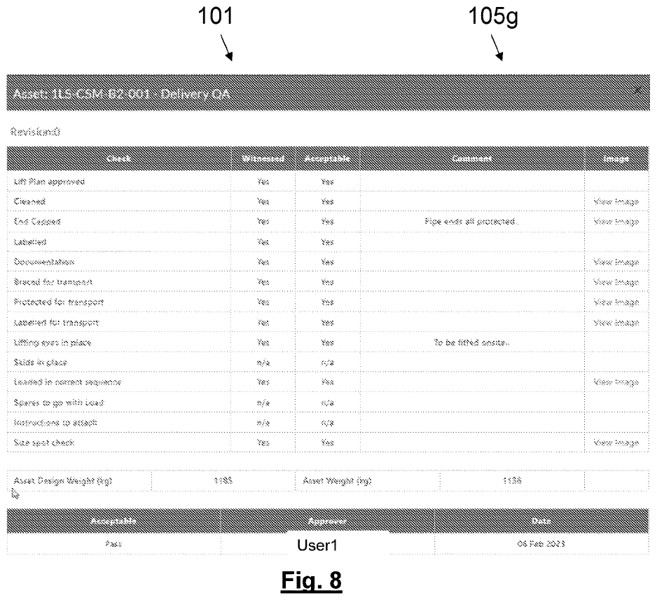

The asset quality assurance interface 105 may include a delivery interface 105g (see e.g. FIG. 8). The asset interface 103, and optionally the asset quality assurance interface 105, may include a link to the delivery interface 105g. For example, the asset quality assurance interface 105 may include a delivery interactive component 105d that links to the delivery interface 105g. The delivery interface 105g may be displayed within the asset quality assurance interface 105. The delivery interface 105g may be displayed in a pop-up window. The delivery interface 105g may include asset delivery checks, such as quality assurance and/or quality control checks regarding the delivery of the asset 15. The delivery interface 105g may include editable statuses for the asset delivery checks (e.g. acceptable, unacceptable, not applicable (n/a)).

The delivery interface 105g may include a master status that determines if the asset 15 passes the asset delivery checks. The master status may be set to acceptable or unacceptable (or pass/fail or other equivalent). If the master status is set to acceptable, the asset 15 may pass the asset delivery check, and may proceed to the next stage of quality assurance. The master status may be set to acceptable automatically if the asset 15 passes each asset delivery check. The master status may be set to acceptable manually. In some implementations the master status may be set to acceptable manually even if the asset fails one or more asset delivery checks. The master status may determine whether or not the asset passes this stage of quality assurance. For example, if the master status is set to acceptable, the asset 15 may pass this stage of quality assurance, even if the asset failed one or more of the asset delivery checks.

For example, asset delivery checks may include checking a lift plan is approved for the asset 15; checking the asset 15 has been cleaned; checking the asset 15 has been end capped; checking the asset 15 has been labelled; checking the asset 15 has appropriate documentation; checking the asset 15 has been braced for transport; checking the asset 15 has been protected for transport; checking the asset 15 has been labelled for transport; checking the asset 15 has lifting eyes in place; checking the asset 15 has skids in place; checking the asset 15 has been loaded in the correct sequence; checking the asset 15 has spares to with the load; checking the asset 15 has instructions provided for attaching the asset 15; checking the asset 15 complies with a size spot check; and/or checking the asset 15 weight.

In particular, the asset delivery checks may include checking that the actual asset weight is within a safety tolerance with respect to the asset design weight. The asset design weight may, therefore, be held in the asset monitoring application 10.

The user may edit the status of each asset delivery check in the delivery interface 105g. The asset delivery interface 105g may include a comment section for each asset delivery check. The comment section may enable a user to leave a comment on the or each asset delivery check. The comment may, therefore, be displayed in the delivery interface 105g, if present. The asset delivery interface 105g may include an image section for each asset delivery check. The image section may enable the user to add an image associated with the or each asset delivery check. The image may be displayed directly in the delivery interface 105g or the image section may include a link to the or each image, which may be displayed in a pop up window, for example. The user may, therefore, upload one or more images to the asset monitoring application 10 to support the asset delivery checks.

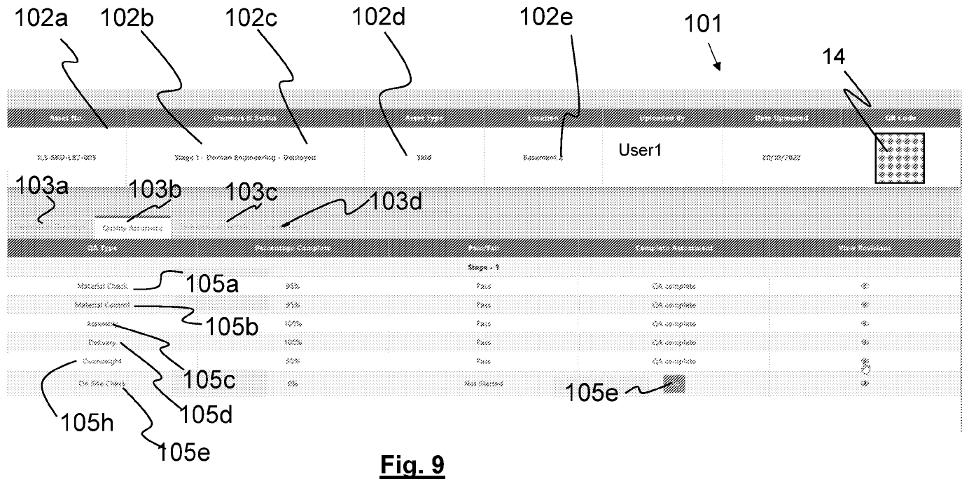

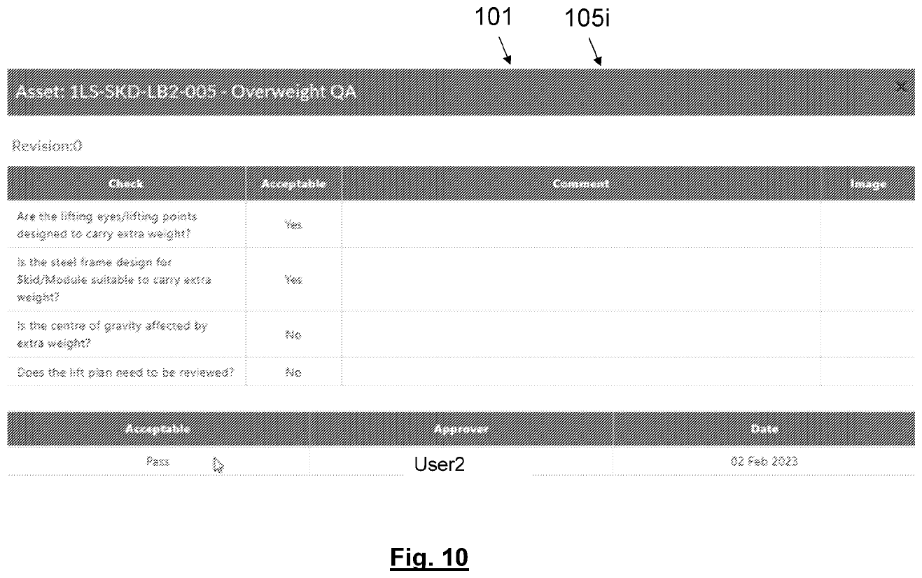

The asset quality assurance interface 105 may include an overweight interface 105i (see e.g. FIG. 10). The asset interface 103, and optionally the asset quality assurance interface 105, may include a link to the overweight interface 105i. For example, the asset quality assurance interface 105 may include an overweight interactive component 105h that links to the overweight interface 105i. The overweight interactive component 105h, and therefore the overweight interface 105i, may only be displayed if the asset 15 weight is found to exceed a design weight in the asset delivery checks (see e.g. FIG. 9).

The overweight interface 105i may be displayed within the asset quality assurance interface 105. The overweight interface 105i may be displayed in a pop-up window. The overweight interface 105i may include asset weight checks, such as quality assurance and/or quality control checks regarding the weight of the asset 15. The overweight interface 105i may include editable statuses for the asset weight checks (e.g. acceptable, unacceptable, not applicable (n/a)).

The overweight interface 105i may include a master status that determines if the asset 15 passes the asset overweight checks. The master status may be set to acceptable or unacceptable (or pass/fail or other equivalent). If the master status is set to acceptable, the asset 15 may pass the asset overweight check, and may proceed to the next stage of quality assurance. The master status may be set to acceptable automatically if the asset 15 passes each asset overweight check. The master status may be set to acceptable manually. In some implementations the master status may be set to acceptable manually even if the asset fails one or more asset overweight checks. The master status may determine whether or not the asset passes this stage of quality assurance. For example, if the master status is set to acceptable, the asset 15 may pass this stage of quality assurance, even if the asset failed one or more of the asset overweight checks.

For example, asset weight checks may include checking if lifting eyes or lifting points associated with the asset 15 are designed to carry extra weight above the design weight; checking if the steel frame design for the skid/module associated with the asset 15 is suitable to carry extra weight above the design weight; checking if the centre of gravity of the asset 15 is affected by the extra weight above the design weight; and/or checking if an asset 15 lift plan needs to be reviewed in view of the extra weight above the design weight.

The user may edit the status of each asset weight check in the overweight interface 105i. The overweight interface 105i may include a comment section for each asset weight check. The comment section may enable a user to leave a comment on the or each asset weight check. The comment may, therefore, be displayed in the overweight interface 105i, if present. The overweight interface 105g may include an image section for each asset delivery check. The image section may enable the user to add an image associated with the or each asset weight check. The image may be displayed directly in the overweight interface 105i or the image section may include a link to the or each image, which may be displayed in a pop up window, for example. The user may, therefore, upload one or more images to the asset monitoring application 10 to support the asset weight checks.

The asset quality assurance interface 105 may include an on site check interface (not shown). The asset interface 103, and optionally the asset quality assurance interface 105, may include a link to the on site check interface. For example, the asset quality assurance interface 105 may include an on site check interactive component 105e that links to the on site check interface. The on site check interface may be displayed within the asset quality assurance interface 105. The on site check interface may be displayed in a pop-up window. The on site check interface may include asset on site checks, such as quality assurance and/or quality control checks regarding the asset to be performed after deployment. This may include checks that the asset has not been damaged in transit, and/or that the asset complies with the asset characteristics held in the asset monitoring application 10, for example. The on site check interface may include editable statuses for the asset on site checks (e.g. acceptable, unacceptable, not applicable (n/a)).

The on site check interface may include a master status that determines if the asset 15 passes the asset on site checks. The master status may be set to acceptable or unacceptable (or pass/fail or other equivalent). If the master status is set to acceptable, the asset 15 may pass the asset on site checks, and may proceed to the next stage of quality assurance. The master status may be set to acceptable automatically if the asset 15 passes each asset on site check. The master status may be set to acceptable manually. In some implementations the master status may be set to acceptable manually even if the asset fails one or more asset on site checks. The master status may determine whether or not the asset passes this stage of quality assurance. For example, if the master status is set to acceptable, the asset 15 may pass this stage of quality assurance, even if the asset failed one or more of the asset on site checks.

The asset interface 103 may include an asset technical submittals interface (not shown). The asset interface 103 may include a link to the asset technical submittals interface. For example, the asset interface 103 may include an asset technical submittals interactive component 103c that links to the asset technical submittals interface. The asset technical submittals interface may be displayed within the asset interface 103.

The asset technical submittals interface may display technical submittals associated with the asset 15. The asset technical submittals interface may display a list of technical submittals associated with the asset 15. The asset technical submittals interface may include one or more links to technical submittals associated with the asset 15. For example, the asset technical submittals interface may include a list of technical submittals associated with the asset 15, and the entries in the list may link to a corresponding technical submittal. A user may, therefore, view technical submittals for the asset 15. The technical submittals are an example of an asset characteristic. Accordingly, the tag 14 may link to, or enable a user to access, the technical submittals for the asset 15. The user may then use the technical submittals to verify that the asset 15 complies with safety criteria.

The asset technical submittals interface may include a technical submittals addition interactive component for adding technical submittals to the asset characteristics. The technical submittals addition interactive component may enable bulk addition of technical submittals and/or single addition of a technical submittal. The technical submittals may, therefore, be uploaded to the asset monitoring application 10, and may be stored on the server 11, for example.

The asset interface 103 may include an issues log interface (not shown). The asset interface 103 may include a link to the issues log interface. For example, the asset interface 103 may include an issues log interactive component 103d that links to the issues log interface. The issues log interface may be displayed within the asset interface 103.

The issues log interface may display an issues log associated with the asset 15. The asset issues log interface may display a list of issues logged in association with the asset 15. The issues log interface may include one or more links to issues log entries associated with the asset 15. For example, the issues log interface may include a list of issues logged in association with the asset 15, and the entries in the list may link to a corresponding issues log entry. A user may, therefore, view issues logged for the asset 15. The issues log entries are an example of an asset characteristic. Accordingly, the tag 14 may link to, or enable a user to access, the issues log for the asset 15. The user may then use the issues log to verify that the asset 15 complies with safety criteria. For example, the issues log may identify issues such as defects associated with the asset 15, which can be used by the user to verify that the issues have been rectified.

The issues log interface may include an issues log addition interactive component for adding issues log entries to the asset characteristics. The issues log addition interactive component may enable bulk addition of issues log entries and/or single addition of an issues log entry. The issues log may, therefore, be uploaded to the asset monitoring application 10, and may be stored on the server 11, for example.

The asset interface 103 may include an asset operation and maintenance (O&M) interface (not shown). The asset interface 103 may include a link to the asset O&M interface. For example, the asset interface 103 may include an asset O&M interactive component (not shown) that links to the asset O&M interface. The asset O&M interface may be displayed within the asset interface 103.

The asset O&M interface may display O&M documents associated with the asset 15. The asset O&M interface may display a list of O&M documents associated with the asset 15. The O&M documents may include operation and maintenance instructions for the asset 15 or a component of the asset 15. The O&M documents may, therefore, include safety criteria for the asset 15. The asset O&M interface may include one or more links to O&M documents associated with the asset 15. For example, the asset O&M interface may include a list of O&M documents associated with the asset 15, and the entries in the list may link to a corresponding O&M document. A user may, therefore, view O&M documents for the asset 15. The O&M documents are an example of an asset characteristic. Accordingly, the tag 14 may link to, or enable a user to access, the O&M documents for the asset 15. The user may then use the O&M documents to verify that the asset 15 complies with safety criteria (e.g. that the asset has been assembled according to the O&M instructions).

The asset O&M interface may include an O&M addition interactive component for adding O&M documents to the asset characteristics. The O&M addition interactive component may enable bulk addition of O&M documents and/or single addition of an O&M document. The O&M document may, therefore, be uploaded to the asset monitoring application 10, and may be stored on the server 11, for example.

Asset characteristics generally include any information associated with the asset 15, including asset label 102a (e.g. name or number), asset owner 102b, asset status 102c, asset type 102d, asset location 102e, asset design weight, asset drawings 204, quality assurance criteria, technical submittals, O&M documents and/or an issues log for the asset 15. The asset characteristics may, therefore, include safety criteria associated with the asset 15. Safety criteria are criteria with which the asset must comply to be safe. Examples of safety criteria include asset drawings 204, quality assurance criteria, asset design weight, technical submittals, and O&M instructions. For example, an asset that is not assembled according to its asset drawings 204 poses a safety risk. Similarly, an asset 15 that does not meet the required quality assurance standards, or comply with approved technical submittals or O&M instructions, also poses a safety risk. It is, therefore, important for users to have easy access to asset safety criteria, and to be confident that the safety criteria correspond to that specific asset 15, to ensure the safety of the asset 15.

An asset deployment plan may be held in the asset monitoring application 10. The asset deployment plan may specify a plan for the deployment of the asset 15. This may include transport and/or delivery and/or installation plans, for example. The asset deployment plan may be based on the asset characteristics and/or safety criteria. In particular, the asset deployment plan may be based at least partly on the asset design weight.

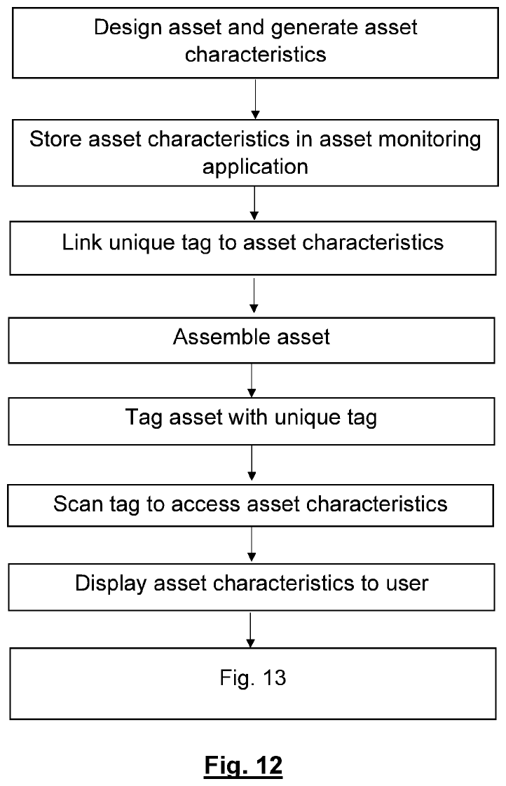

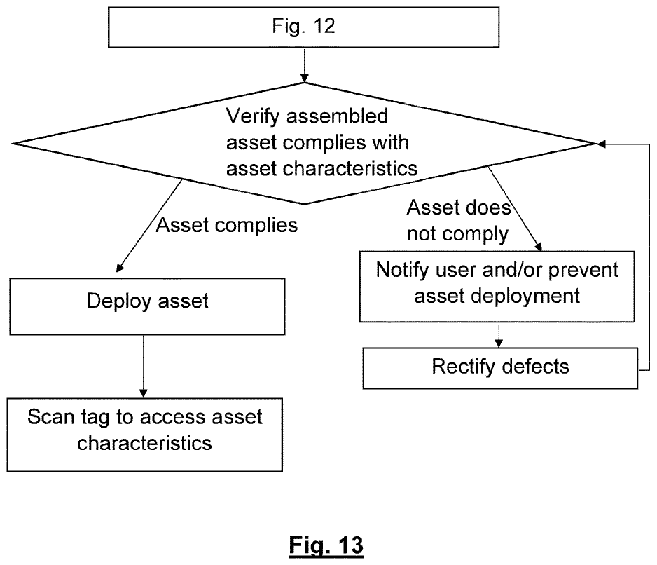

The disclosed technology includes an asset monitoring method (see e.g. FIGS. 12-13), which may be a method for monitoring a construction asset.

The method may include designing the asset 15. Designing the asset 15 may include generating one or more asset characteristics associated with the asset 15. The asset characteristics may, as described, include safety criteria. The asset 15 may, therefore, be designed according to the needs of a project. Designing the asset 15 may include preparing one or more asset drawings 204, quality assurance criteria, and/or technical submittals associated with the asset 15. In some versions, the asset 15 may be designed and the asset characteristics generated by a first entity (e.g. a designer). The asset 15 design and/or asset characteristics may be provided to a second entity (e.g. a manufacturer).

The method may include uploading the asset characteristics to the asset monitoring application 10. The method may include storing the asset characteristics in the asset monitoring application 10. The asset characteristics may, therefore, be stored on one or more of the servers 11 and/or user devices 12.

The method may include generating the asset interface 103 for the or each asset 15, which, as described, may display the asset characteristics and/or a representation of the tag 14 associated with the asset 15.

The method may include generating the tag 14 and/or linking the tag 14 to the asset characteristics. The method may, therefore, include generating a QR code 14 and/or linking the QR code 14 to the asset characteristics. The tag 14 may be linked to the asset characteristics such that scanning the tag 14 with the user device 12 and/or tag scanning device enables the user to access the asset characteristics. For example, scanning the tag 14 with the user device 12 may cause the user device 12 to display the asset interface 103 and/or asset characteristics to the user.

The method may include populating the asset interface 103 with one or more asset characteristics, and optionally one or more asset safety criteria. For example, the method may include adding one or more asset drawings 204, quality assurance criteria, technical submittals, and/or O&M documents to the asset monitoring system 10 and/or asset interface 103.

The method may include assembling the asset 15. The asset 15 may be assembled according to the asset characteristics, e.g. according to the asset drawings 204. Assembling the asset 15 may include manufacturing or procuring one or more components of the asset 15 and assembling those components to form the asset 15. The asset 15 may be assembled according to one or more safety criteria, e.g. to comply with the safety criteria. In the case of a complex asset 15, for example, assembling the asset 15 may include assembling the component parts to form the complex asset 15.

The method may include tagging the asset 15 with the tag 14 which, as described, may be a unique scannable tag 14, and may therefore identify the asset 15. Tagging the asset 15 with the tag 14 may include attaching the tag 14 to the asset 15, for example using an adhesive.

The method may include scanning the tag 14, optionally using the user device 12, to access the asset characteristics (which may include safety criteria). The asset characteristics may be displayed on the user device 12 or on another device. For example, a tag scanning device may be linked to a display, and the asset characteristics may be displayed on the display. The method may, therefore, include displaying the asset characteristics (and optionally safety criteria) to a user. The method may include displaying the user interface 101 of the asset monitoring application 10 to the user, and optionally displaying the asset interface 103 to the user.

The method may include verifying that the asset 15 complies with one or more asset characteristics and/or safety criteria which, as described, may be held in the asset monitoring application 10. Verifying that the asset 15 complies with the one or more asset characteristics and/or safety criteria may include inspecting the asset 15 and/or comparing the asset 15 to the asset characteristics to identify any defects in the asset 15. The verification process may be performed by a user. In some versions, all or part of the verification process may be automated, for example using one or more robots or automated systems. Such robots or systems may include appropriate sensors, such as one or more cameras, to perform the verification.

The method may include notifying a user if the asset 15 does not comply with the one or more asset characteristics and/or safety criteria. The method may include deploying the asset 15 if the asset complies with the asset characteristics and/or safety criteria. The method may include preventing the deployment of the asset 15 if the asset 15 does not comply with the asset characteristics and/or safety criteria.

The method may include rectifying any defects in the asset 15. A defect may be any aspect that causes the asset 15 not to comply with the asset characteristics and/or safety criteria. Rectifying the asset defects may, therefore, ensure that the asset 15 complies with the asset characteristics and/or safety criteria.

The method may include verifying that the rectified asset 15 complies with the asset characteristics and/or safety criteria. If the asset 15 is still found not to comply, the asset may again be prevented from deployment and further rectifications may be performed. If the rectified asset 15 complies with the asset characteristics and/or safety criteria, the rectified asset 15 may be deployed.

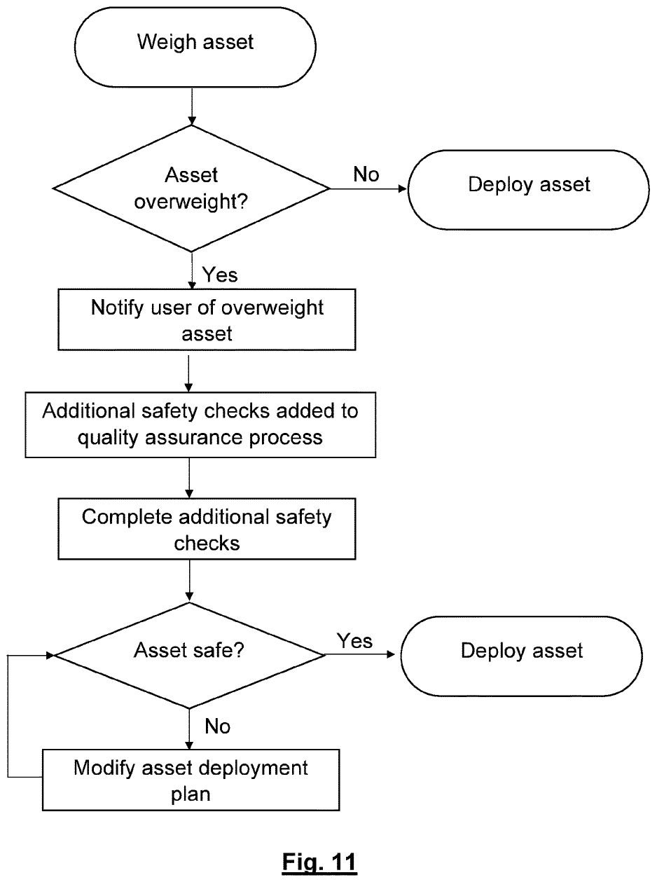

The verification process may include a quality control method (see e.g. FIG. 11), which may therefore be a quality control method for a construction asset 15. The quality control method may include assembling the asset 15. The quality control method may include weighing the asset 15 to determine its actual weight. The weighing may be performed before the asset is deployed. Deploying the asset 15 may include transporting the asset 15 and/or delivering the asset 15 to a construction site and/or using the asset 15 to construct a construction. The quality control method may include comparing the actual weight to the asset design weight. The quality control method may include notifying a user if the actual weight falls outside a safety tolerance with respect to the asset design weight.

The quality control method may include assembling the asset 15, the asset 15 having a design weight; weighing the asset 15 before deployment to determine its actual weight; and notifying a user if the actual weight falls outside a safety tolerance with respect to the design weight.

The safety tolerance may be implemented as a percentage tolerance with respect to the design weight, such as a 20%, 15%, 10%, 5%, or 1% tolerance with respect to the design weight. The safety tolerance may additionally or alternatively include an absolute tolerance with respect to the design weight. For example, the safety tolerance may be up to 10 kg, up to 20 kg, up to 30 kg, up to 40 kg, up to 50 kg, up to 60 kg, up to 70 kg, up to 80 kg, up to 90 kg, up to 100 kg, up to 150 kg, or up to 200 kg from the design weight. The safety tolerance may, therefore, include a percentage tolerance and an absolute limit. For example, the safety tolerance may be 10%, with a cap of 50 kg, with respect to the design weight. In other versions the safety tolerance may be a flat 50 kg tolerance with respect to the design weight.

An absolute safety tolerance of 50 kg has been found to be particularly effective for ensuring asset safety. Therefore, the method may include notifying a user if the actual weight is more than 50 kg greater than the design weight.

The step of weighing the asset 15 may be performed using the weighing device 16. The weighing device 16 may be configured to send the asset weight to the asset monitoring application 10 automatically, for example using the network 13. The user may read the asset weight from the asset weighing device 16 and input the asset weight to the asset monitoring application 10. The weighing device 16 may, therefore, be linked to the asset monitoring application 10. Scanning the tag 14 may link the weighing device 16 to the asset interface 103, which may therefore enable automatic uploading of the actual asset weight to the asset characteristics.

Notifying a user may include issuing an alert to the user (e.g. a visual and/or audio alert). The user may be notified via the asset monitoring application 10. The asset monitoring application 10 may notify the user that the asset 15 is overweight, and the notification may be automatic. In other words, the asset monitoring application 10 may be configured to notify a user automatically that the asset 15 is overweight if the actual weight uploaded to the asset monitoring application 10 falls outside the safety tolerance. For example, the asset monitoring application 10 may notify the user via the user device 12. The asset monitoring application 10 may automatically send an email to a user to notify the user that the asset 15 is overweight.

The quality control method may include deploying the asset if the actual weight falls within the safety tolerance with respect to the design weight. The quality control method may include inputting the actual weight to the asset monitoring application 10 and verifying if the actual weight passes one or more asset weight checks held in the asset monitoring application 10, wherein the asset design weight is held in the asset monitoring application 10. The asset weight checks may be displayed in the overweight interface 105i. The asset weight checks may be carried out by a user and the user may update the status of each asset weight check accordingly.

The asset weight checks may only be included in the method if the asset 15 falls outside the safety tolerance with respect to the design weight.

The quality control method may include preventing the deployment of the asset 15 if the asset 15 does not pass one or all of the asset weight checks. The asset 15 may therefore not be transported and/or installed if the asset does not pass one or all of the asset weight checks.

The asset 15 may have an associated asset deployment plan which, as described, may be held in the asset monitoring application 10. In some implementations the asset deployment plan may be held elsewhere. The quality control method may include modifying the asset deployment plan based on the actual weight to generate a modified asset deployment plan that is compatible with the actual weight, and optionally deploying the asset according to the modified asset deployment plan. The method may, therefore, include altering the asset deployment plan to accommodate the increased asset weight compared to the design weight. For example, the modified asset deployment plan may include a different mode of transport, different transport route, and/or different asset handling equipment than initially planned. For example, where the asset 15 deployment includes the use of a temporary floor or scaffolding, such structures may require reinforcement or alteration to accommodate the increased asset weight.

Modifying the asset deployment plan may, therefore, include adapting the asset deployment plan for safe deployment of the asset 15.

The quality control method may include verifying that the asset 15 is compatible with the modified asset deployment plan. If the asset 15 is compatible with the modified asset deployment plan, the asset 15 may be deployed according to the modified plan; if the asset is not compatible with the modified plan, the plan may be further modified until the asset 15 is compatible with the plan, and the asset 15 then deployed according to the compatible deployment plan.

The quality control method may include scanning the tag 14 to access the asset characteristics held in the asset monitoring application 10, which may include the asset design weight. The tag 14 may be scanned before the asset 15 is weighed. The tag 14 may be scanned after the asset 15 is weighed, but optionally before the asset is deployed. The method may include updating the asset characteristics with the actual weight. The asset monitoring application 10 may, therefore, be used to determine the safety tolerance and/or to notify the user if the asset is overweight.

The quality control method may, therefore, ensure safe deployment of the asset 15, including safe transport and/or installation of the asset 15. The quality control method may prevent safety risks and/or injuries resulting from any deviation between the actual asset weight and the asset design weight.

A quality control system for an asset 15, optionally a construction asset 15, may therefore include the weighing device 16 and/or asset monitoring application 10. The quality control system may include the tag 14 and/or user device 12 and/or server 11 and/or network 13.

The asset monitoring method may, therefore, include the quality control method.

Returning to the asset monitoring method, the method may include transferring the transferring the asset 15 from a first entity to a second entity. For example, the first entity may be an entity that performs the assembly and/or quality assurance procedures. The second entity may be a client. The second entity may scan the tag 14 to access the asset characteristics. The second entity may, therefore, confirm that the asset 15 complies with the asset characteristics. In such a manner, a client, for example a construction company, may confirm that the asset 15 complies with the asset characteristics and is therefore safe.

An asset monitoring system, optionally a construction asset monitoring system, may include the asset monitoring application and the tag 14. The asset monitoring application may include the user device 12 and/or device for scanning the scannable tag and/or weighing device 16 and/or server 11 and/or network 13.

The asset monitoring system and method may therefore link an asset 15 to its asset characteristics, which may include safety criteria established in a design phase. It is essential for safety that the assembled asset 15 complies with the asset characteristics. However, determining the intended asset characteristics for a particular asset can be difficult and therefore prone to error. This may lead to safety risks. The disclosed systems and methods link the asset 15 to its asset characteristics from the design phase through to deployment, enabling easy and reliable verification of the asset characteristics. Furthermore, the disclosed quality control method and system ensure that overweight assets do not cause safety risks, particularly for construction assets.

The disclosed technology includes a processing device 30 (see e.g. FIG. 17) configured to run the asset monitoring application 10. The processing device 30 may be operable to communicate with a storage device 31. The processing device 30 may, therefore, be communicatively coupled to the storage device 31. The storage device 31 may be a part of the server 11 and/or user device 12, for example. Data used by the asset monitoring application 10, such as the asset characteristics, may be stored in the storage device 31.

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

1. A quality control method for a construction asset, comprising:
assembling a construction asset having a design weight;
weighing the asset before deployment to determine its actual weight; and
notifying a user if the actual weight falls outside a safety tolerance with respect to the design weight.

2. A method according to claim 1, wherein the construction asset is a complex construction asset comprising a plurality of component parts permitting disassembly and reassembly of the complex construction asset.

3. A method according to claim 1, further including deploying the asset if the actual weight falls within the safety tolerance with respect to the design weight.

4. A method according to claim 1, further including inputting the actual weight to an asset monitoring application and verifying if the actual weight passes one or more asset weight checks held in the asset monitoring application, wherein the asset design weight is held in the asset monitoring application.

5. A method according to claim 4, further including preventing the deployment of the asset if the asset does not pass one or all of the asset weight checks.

6. A method according to claim 5, wherein when the asset does not pass one or all of the asset weight checks, the method includes modifying an asset deployment plan based on the actual weight to generate a modified asset deployment plan that is compatible with the actual weight, and optionally deploying the asset according to the modified asset deployment plan.

7. A method according to claim 4, further including:
scanning a unique tag associated with the asset to access asset characteristics held in the asset monitoring application including the asset design weight; and
updating the asset characteristics with the actual weight.

8. A method according to claim 7, wherein the asset characteristics are automatically updated with the actual weight.

9. A method according to claim 4, wherein the notification that the actual weight falls outside a safety tolerance with respect to the design weight is issued automatically by the asset monitoring application.

10. A quality control system for a construction asset, comprising:
a processing device configured to run an asset monitoring application and operable to communicate with a storage device holding asset characteristics including an asset design weight for the construction asset,
wherein the asset monitoring application is configured to receive an actual asset weight for the construction asset and to compare the actual asset weight to the asset design weight,
wherein the asset monitoring application is configured to notify a user if the actual asset weight falls outside a safety tolerance with respect to the asset design weight.

11. A quality control system according to claim 10, further including a scannable tag for association with the construction asset, wherein the scannable tag is linked to the asset characteristics.

12. A quality control system according to claim 11, wherein the scannable tag is a QR code.

13. A quality control system according to claim 11, further including a user device configured to scan the scannable tag.

14. A method for monitoring a construction asset, comprising:
storing asset characteristics associated with the construction asset in an asset monitoring application;
linking a unique scannable tag to the asset characteristics;
tagging the construction asset with the unique scannable tag; and
scanning the tag to access the asset characteristics.

15. A method according to claim 14, including displaying the asset characteristics to a user.

16. A method according to claim 14, wherein the construction asset is a complex construction asset comprising a plurality of component parts permitting disassembly and reassembly of the complex construction asset.

17. A method according to claim 14, wherein the asset characteristics include safety criteria associated with the asset.

18. A method according to claim 17, including verifying that the asset complies with the safety criteria.

19. A method according to claim 18, including notifying a user if the asset does not comply with the safety criteria.

20. A method according to claim 18, including deploying the asset if the asset complies with the safety criteria, and preventing the deployment of the asset if the asset does not comply with the safety criteria.

21. (canceled)

22. (canceled)

23. (canceled)

24. (canceled)

25. (canceled)
